(19) United States
(12) Patent Application Publication
(10) Pub. No.: US 2025/0386246 A1
(43) Pub. Date: Dec. 18, 2025

(54) LEVERAGING GENERATIVE-ARTIFICIAL INTELLIGENCE (AI) FOR INTELLIGENT RESOURCE SHARING/EXCHANGE

(71) Applicant: AT&T Mobility II LLC, Atlanta, GA (US)

(72) Inventors: Effendi Jubilee, Gaithersburg, MD (US); Ming-Ju Ho, Alpharetta, GA (US)

(73) Assignee: AT&T Mobility II LLC, Atlanta, GA (US)

(21) Appl. No.: 18/743,632

(22) Filed: Jun. 14, 2024

(51) Int. Cl. H04W 28/084; H04L 5/00; H04W 16/14

(52) U.S. Cl. CPC H04W 28/084; H04L 5/0023; H04L 5/0048; H04W 16/14

(57) ABSTRACT

Aspects of the subject disclosure may include, for example, a device, comprising a first processing system associated with a first operator of a first network and including a processor, and a memory that stores executable instructions that, when executed by the first processing system, facilitate performance of operations. The operations may include receiving, from a second processing system associated with a second operator of a second network, a request to share one or more radio access network (RAN) resources of the first network, responsive to the receiving the request, utilizing one or more generative AI models to determine whether the one or more RAN resources are to be shared, resulting in a determination, and based on the determination indicating that the one or more RAN resources are to be shared, causing the one or more RAN resources to be allocated for use by the second network. Other embodiments are disclosed.

### FIELD OF THE DISCLOSURE

The subject disclosure relates to leveraging generative artificial intelligence (AI) for intelligent sharing/exchange of resources (e.g., spectrum, beamforming capabilities, electrical tilt capabilities, transmit (Tx) power capabilities, etc.).

### BACKGROUND

A radio access network (RAN) is a major subsystem that connects individual devices to parts of a wireless telecommunications network by way of radio links. A typical RAN base station has three main components—antennas that convert electrical signals into radio waves; a radio unit that transforms digital information into wireless signals and ensures that transmissions are in the correct frequency bands with the appropriate power levels; and a baseband unit (BBU) that provides a set of signal processing functions and overall base station management. The rapid growth of Internet usage, fueled by the proliferation of streaming services, remote work, online education, and technological advancements, has created a surge in demand for faster and more time-sensitive communications. As users increasingly rely on high-bandwidth applications and real-time interactions, networks must adapt to support higher speeds, lower latency, and greater reliability. Spectrum is one of the main resources that network operators use to provide capacity for high-speed data demand and network coverage. Spectrum is a vital, costly, and time-consuming investment for wireless operators, often requiring billions of dollars and extensive time to acquire and deploy. Indeed, operators are generally compelled to bid/acquire new spectrum to support this demand and maintain network performance. Insufficient spectrum can lead to network congestion, slower data speeds, dropped calls, and poor user experience, and can hinder innovation and technology development. Many network operators manage and operate on their own spectrum exclusively. That is, spectrum is generally not shared between different network operators.

In current networks, a given RAN subsystem may have its own unique characteristics, such as those for antenna tilting, Tx power output, and radio parameter settings (e.g., for admission control, handovers, etc.). FIG. 1A illustrates a typical wireless telecommunications network 100. The network 100 includes RAN and core subsystems associated with a network operator. The RAN subsystem includes multiple base stations, each of which includes an antenna 101a, a radio 101r, and a BBU 101b. The BBUs 101b are coupled to core network(s) 101c of the core subsystem via backhaul network(s) 101k. Because a RAN subsystem, with its own unique characteristics, can be connected to different core networks, these cores are generally constrained or subjected to those particular characteristics. Furthermore, network operators own and control their own RAN subsystems. Such exclusivity leads many of them to co-locate their equipment at the same site or on the same tower top, each with their own customized RAN hardware equipment, with no sharing of the equipment between operators. This results in undue overcrowding, structural challenges, and various technical, aesthetic, and bureaucratic issues.

### BRIEF DESCRIPTION OF THE DRAWINGS

Reference will now be made to the accompanying drawings, which are not necessarily drawn to scale, and wherein:

FIG. 1A illustrates a typical wireless telecommunications network.

FIG. 1B is a block diagram illustrating an exemplary, non-limiting embodiment of a communications network in accordance with various aspects described herein.

FIG. 2A illustrates an example network in which a resource sharing platform facilitates resource sharing between network systems of different network operators, in accordance with various aspects described herein.

FIG. 2B illustrates an example grid or layout of base stations equipped with integrated antenna radio units in accordance with various aspects described herein.

FIG. 2C illustrates example implementations of resource exchange proxies/points that respective network operators may provide for handling spectrum exchange requests, in accordance with various aspects described herein.

FIG. 2D illustrates an example spectrum exchange flow between the systems of two network operators, in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of a resource sharing platform that is capable of facilitating sharing or exchanging of resources between network operators. In exemplary embodiments, the resources may include resource blocks in the frequency domain (e.g., spectrum), the time domain, and/or the spatial domain (e.g., via beamforming). Spectrum sharing in particular advantageously improves spectrum utilization efficiency. In various embodiments, the resources may include RAN equipment, such as base stations with certain levels of Tx power output, antennas with certain tilting capabilities, or the like. Resource sharing may be facilitated via (e.g., direct) communications between different operator network systems.

In certain embodiments, individual base stations of a RAN subsystem may be equipped with a universal integrated antenna (UIA) radio unit that has massive multiple-input-multiple-output (MIMO) capabilities, which, as compared to the conventional segregated antenna and radio architecture, may better facilitate the sharing of resources. The UIA radio unit may comply with Open-RAN (O-RAN) standards so as to allow for connections with baseband units that are provided by different vendors. In various embodiments, the UIA radio unit may be capable of facilitating spatial domain resource sharing by providing beamforming and unique antenna tilting and/or Tx power allocations for network systems of different network operators. With a reduced need for each operator to have their own equipment on a given tower, the UIA radio unit may be equipped with even more antenna elements and designed to transmit at even higher power as compared to current antenna systems.

In one or more embodiments, the resource sharing platform may leverage or be integrated with generative AI capabilities that enable decision-making for resource sharing. Employing a resource sharing architecture with UIA radio units coupled with generative AI enables a network operator to independently build a unique RAN subsystem according to their own criteria, which advantageously overcomes the aforementioned single characteristic RAN subsystem limitation. In this way, similar to network virtualization, generative AI-triggered UIA radio units allow different network systems/operators to customize their RAN subsystem characteristics using a common hardware platform. A given network operator can thus share some of its RAN subsystem resources in return for a revenue stream. For instance, up-and-coming operators can “rent” RAN subsystem resources to expedite their network build-out without having to start from scratch, which is otherwise costly and time consuming. Having fewer RAN components, such as antennas, radio units, etc. on a tower top also expedites the zoning and permit process and promotes a greener environment. Aggregation of shared spectrum also improves capacity, which can address the ever-increasing demand for time-sensitive applications. Spectrum sharing also reduces the need for an operator to aggressively purchase spectrum, thereby reducing costs on that end. The more spectrum bands that are used by network operators, the more complicated it is to design/handle hardware and interference/intermodulation (IM). Embodiments of resource sharing described herein address this by reducing the need for more spectrum bands, which simplifies overall network complexity.

One or more aspects of the subject disclosure include a device, comprising a first processing system associated with a first operator of a first network and including a processor, and a memory that stores executable instructions that, when executed by the first processing system, facilitate performance of operations. The operations can include receiving, from a second processing system associated with a second operator of a second network, a request to share one or more radio access network (RAN) resources of the first network. Further, the operations can include responsive to the receiving the request, utilizing one or more generative artificial intelligence (AI) models to determine whether the one or more RAN resources are to be shared, resulting in a determination. Further, the operations can include based on the determination indicating that the one or more RAN resources are to be shared, causing the one or more RAN resources to be allocated for use by the second network.

One or more aspects of the subject disclosure include a non-transitory machine-readable medium, comprising executable instructions that, when executed by a first processing system associated with a first operator of a first network and including a processor, facilitate performance of operations. The operations can include submitting, to a second processing system associated with a second operator of a second network, a request to share one or more radio access network (RAN) resources of the second network, wherein the submitting causes a generative artificial intelligence (AI) model associated with the second processing system to determine whether the one or more RAN resources are to be shared, resulting in a determination. Further, the operations can include based on the determination, receiving, from the second processing system, an indication of the one or more RAN resources being allocated for use by the first network.

One or more aspects of the subject disclosure include a method. The method can comprise obtaining, by a first processing system associated with a first operator of a first network and including a processor, a request to share one or more radio access network (RAN) resources of the first network, wherein the request is obtained from a second processing system associated with a second operator of a second network. Further, the method can include responsive to the obtaining the request, leveraging, by the first processing system, one or more generative artificial intelligence (AI) models to determine whether the one or more RAN resources are to be shared, resulting in a determination. Further, the method can include based on the determination indicating that the one or more RAN resources are to be shared, causing, by the first processing system, the one or more RAN resources to be allocated for use by the second network, wherein the one or more RAN resources include particular spectrum associated with the first network.

Other embodiments are described in the subject disclosure.

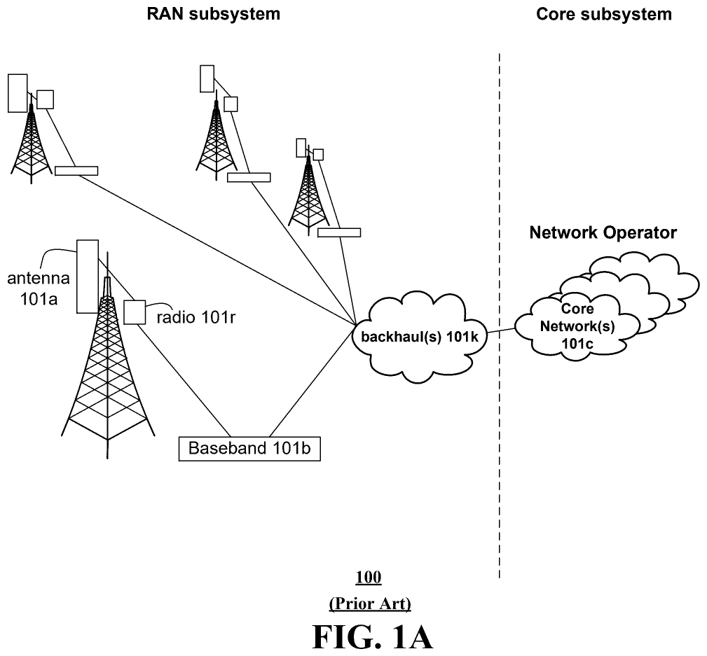

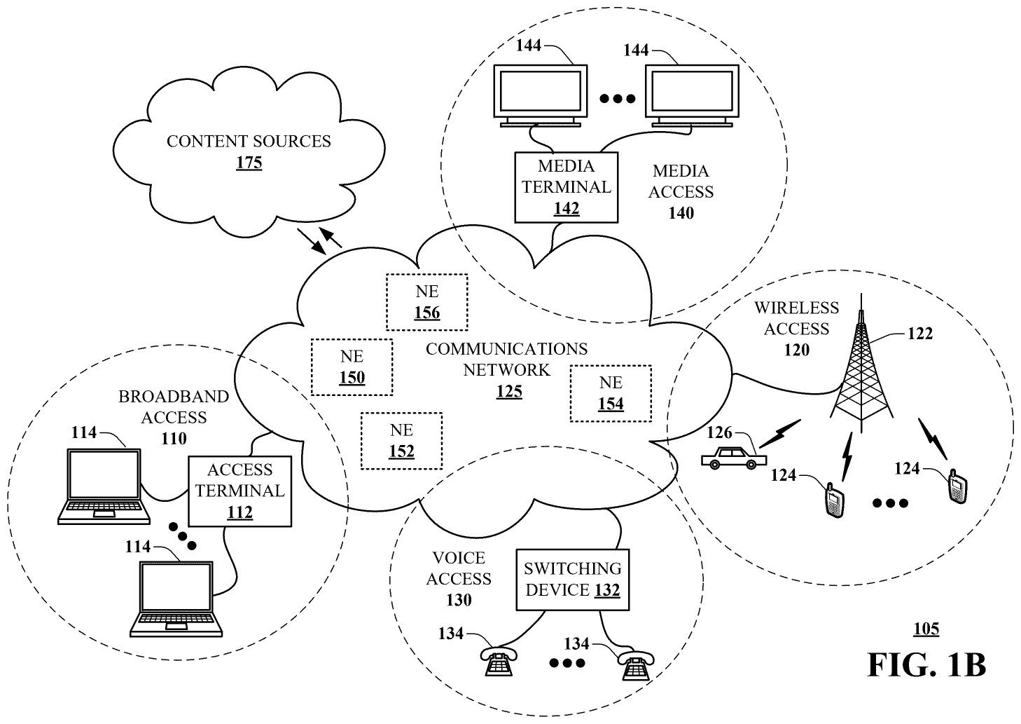

Referring now to FIG. 1B, a block diagram is shown illustrating an example, non-limiting embodiment of a system 105 in accordance with various aspects described herein. For example, system 105 can facilitate, in whole or in part, leveraging of generative AI for intelligent sharing/exchange of resources (e.g., spectrum, beamforming capabilities, electrical tilt capabilities, Tx power capabilities, etc.). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

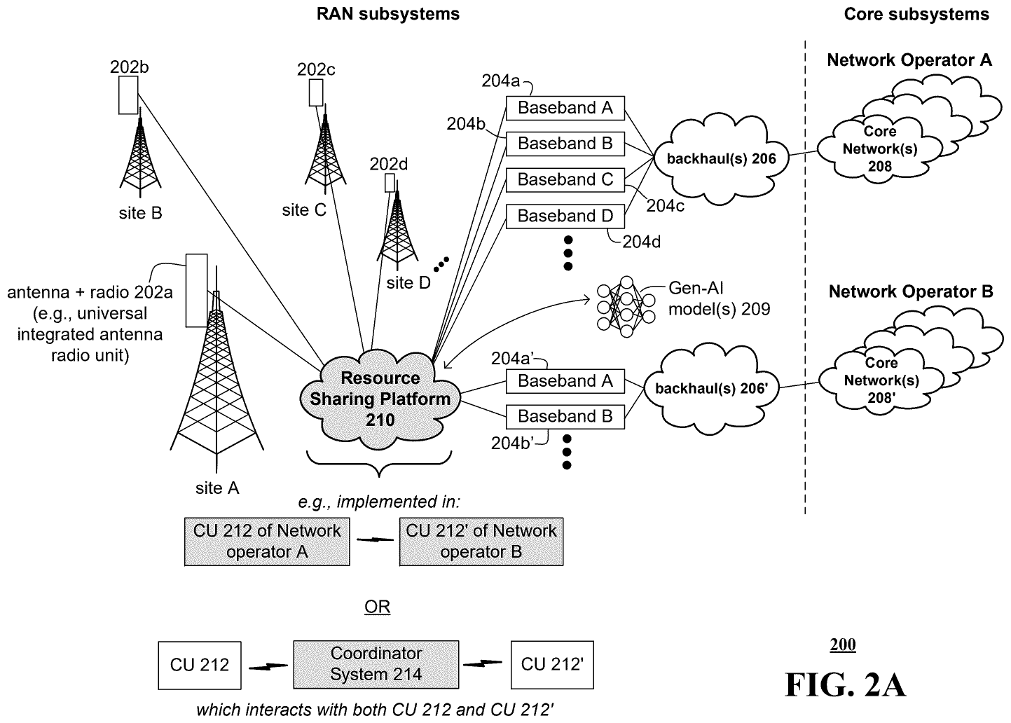

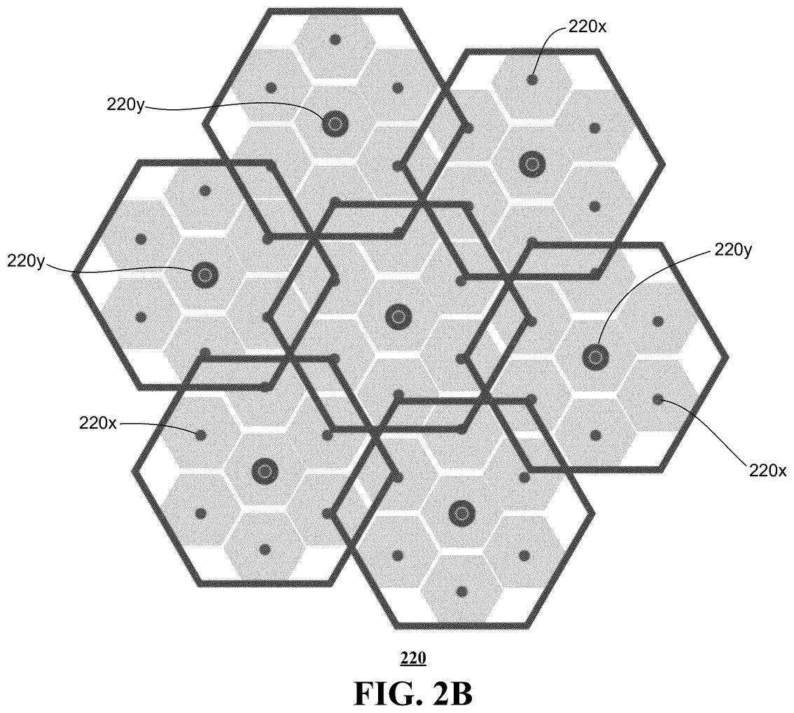

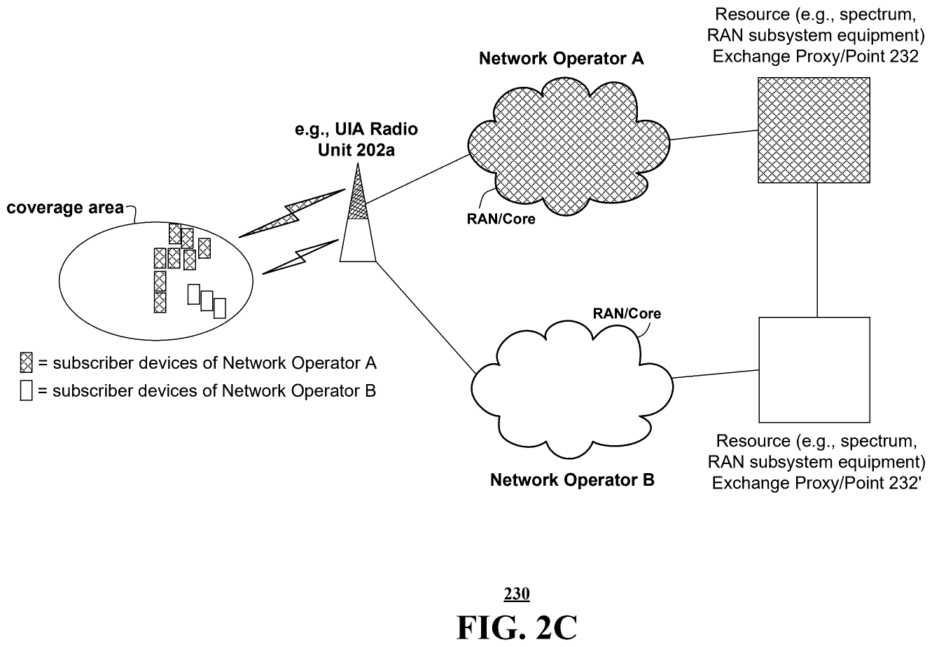

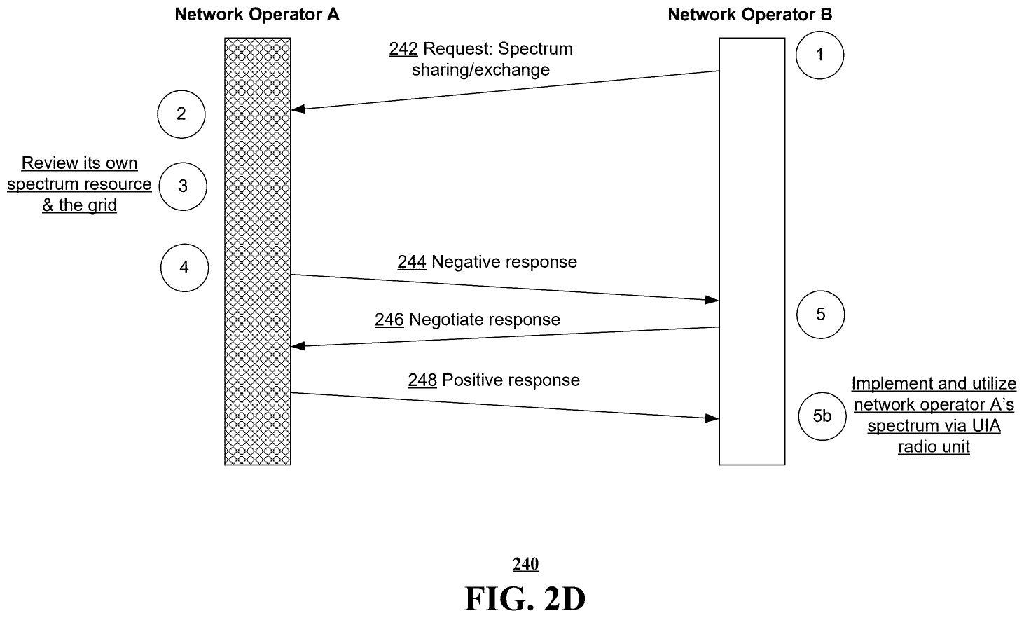

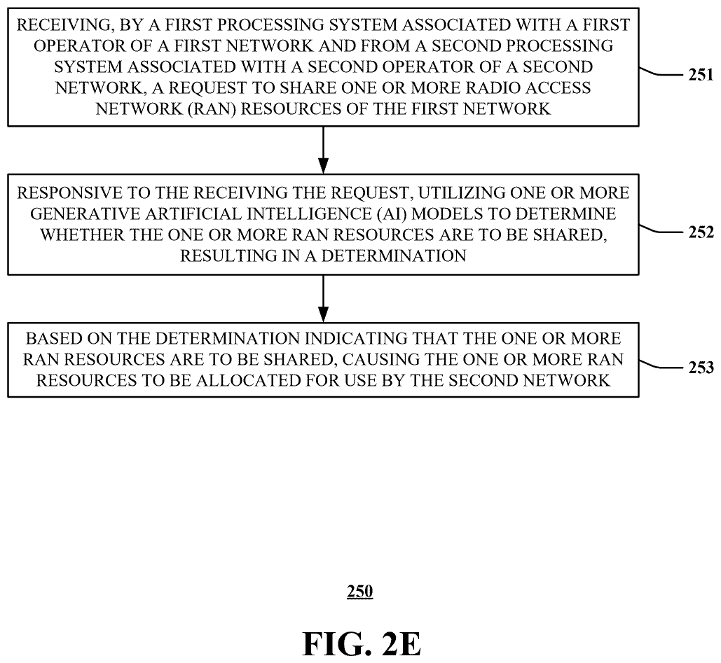

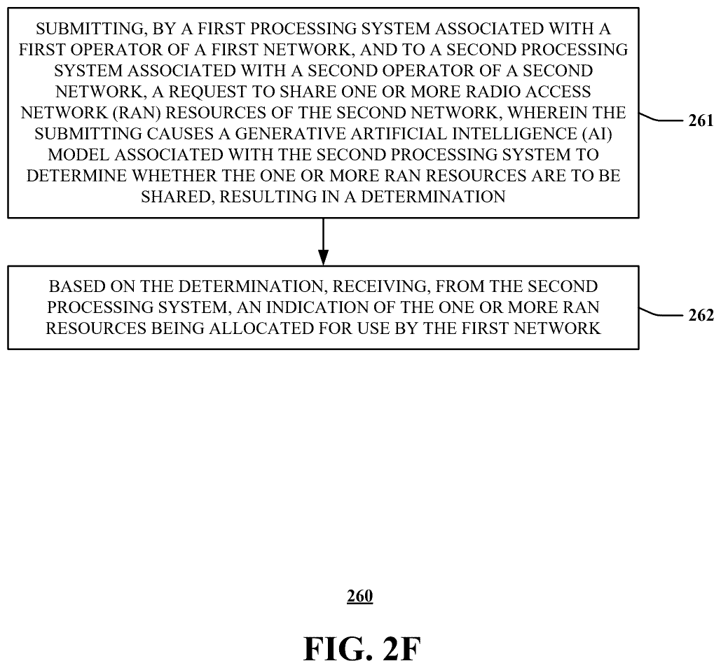

FIG. 2A illustrates an example network 200 in which a resource sharing platform 210 facilitates resource sharing between network systems of different network operators, in accordance with various aspects described herein. The network 200 may include a RAN subsystem and core network(s) 208 associated with a network operator A, and a RAN subsystem and core network(s) 208′ associated with a network operator B.

The core network(s) 208 of network operator A may include network devices and/or systems that provide a variety of functions. In certain embodiments, a core network 208 may be implemented in a cloud architecture. Examples of functions provided by, or included, in a core network 208 include an access mobility function (AMF) configured to facilitate mobility management in a control plane of the network system (including, for instance, providing user equipment (UE) mobility information associated with one or more RANs and/or UEs to the core network 208), a user plane function (UPF) configured to provide access to a data network, such as a packet data network (PDN), in a user (or data) plane of the network system, a Unified Data Management (UDM) function, a Session Management Function (SMF), a policy control function (PCF), and/or the like. A core network 208 may be in communication with one or more other networks (e.g., one or more content delivery networks (CDNs)), one or more services, and/or one or more other devices. In one or more embodiments, a core network 208 may include one or more devices implementing other functions, such as a master user database server device for network access management, a PDN gateway server device for facilitating access to a PDN, and/or the like. A core network 208 may include various physical/virtual resources, including server devices, virtual environments, databases, and so on. Core network(s) 208′ of network operator B may be similar to the core network(s) 208.

The RAN subsystem of network operator A may include a wireless RAN, a Wi-Fi network, and/or a wireline network, and may include network resources, such as one or more physical access resources and/or one or more virtual access resources. Physical access resources can include base station(s) (e.g., one or more eNodeBs, one or more gNodeBs, or the like), one or more satellites, one or more Gigabyte Passive Optical Networks (GPONs) or related components (e.g., Optical Line Terminal(s) (OLT), Optical Network Unit(s) (ONU), etc.), and/or the like. For instance, four base stations or sites A, B, C, D are illustrated in FIG. 2A, although it is to be understood and appreciated that the RAN subsystem may include more or fewer base stations or sites. A base station may employ any suitable radio access technology (RAT), such as 4G/LTE, 5G, 6G, or any higher generation RAT. One or more edge computing devices (e.g., multi-access edge computing (MEC) devices or the like) may also be included in or associated with the RAN subsystem. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the RAN subsystem may include any number/types of physical/virtual access resources and various types of heterogenous cell configurations with various quantities of cells and/or types of cells. In certain embodiments, the RAN subsystem may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller.

The base stations A, B, C, D may be equipped with antenna and radio units—e.g., UIA radio units 202a, 202b, 202c, 202d, all of which may be implemented as (e.g., passive) distributed radio elements connected to a centralized baseband processing pool—e.g., baseband units 204a, 204b, 204c, 204d (respectively for sites A, B, C, D)—via the resource sharing platform 210. Each antenna and radio unit 202a may include one or more antenna arrays (e.g., massive MIMO arrays). In various embodiments, the unit 202a may include advanced antenna configurations, such as phased arrays with numerous antenna elements, which enables complex beamforming in the horizontal/azimuth direction as well as in the vertical/elevation direction, thereby allowing for precise control of radio signals, confining them to very specific angles. The baseband units 204a, 204b, 204c, 204d may be coupled to the core network(s) 208 via backhaul network(s) 206. The backhaul(s) 206 may be fiber-based and/or may be implemented via wireless point-to-point technologies. In certain embodiments, the backhaul(s) 206 may additionally, or alternatively, be implemented using copper wireline, satellite communications technologies, and/or point-to-multipoint wireless technologies.

The RAN subsystem associated with network operator B may be similar to the RAN subsystem of network operator A, although in FIG. 2A, only a portion thereof is illustrated. That is, the RAN subsystem of network operator B may also include base stations, baseband units, and backhaul(s) 206′ similar to those described above with respect to the RAN subsystem of network operator A. As described in more detail below, however, certain baseband units (204a′, 204b′) of network operator B may be configured to interface with the resource sharing platform 210 to facilitate utilization of resources of network operator A's RAN subsystem.

Although not shown in FIG. 2A, the network 200 may serve UEs whose users may be subscribers of network operator A or network operator B. A UE may be any computing device that is capable of obtaining and/or processing data and communicating information with one or more other devices (e.g., over the network 200). As some non-limiting examples, a UE may be a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)), a biometric sensor (e.g., for monitoring heart rate, blood pressure, pulse, breathing, etc.), an electrical switch controller, a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, a door/lock controller (e.g., for a room door, a garage door, etc.), a tracking device (e.g., for tracking objects on the road, in a factory/warehouse setting, etc.), a vehicle, a similar type of device, a different type of device, or a combination of some or all of these devices.

In one or more embodiments, the resource sharing platform 210 may be implemented in hardware, firmware, or a combination of hardware and software, and may facilitate sharing/exchanging of RAN subsystem resources between network operators A and B. In various embodiments, the resource sharing platform 210 may be implemented in one or more RAN intelligent controllers (RICs) and/or in a system that interfaces RICs. Although not shown, a RIC may include a first RIC portion implemented, or otherwise incorporated, in a network service management platform. The RIC may include a second RIC portion having a control or centralized unit (CU) (e.g., a base station CU, such as a gNodeB (gNB) CU or the like) that provides a CU applications layer as well as a CU control plane (CU-CP) and a CU user plane (CU-UP). In various embodiments, the first RIC portion may be configured to operate in non-real-time, and the second RIC portion may be configured to operate in near real-time. The particular functions performed by the two RIC portions can vary based on various criteria, including implementing changing parameters or requirements for the network, and can also include redundancy and/or dynamic switching of functions between the RIC portions. In various embodiments, the CU may interact with distributed units (DUs) that implement baseband units (here, e.g., baseband units 204a, 204b, 204c, 204d, etc.). In exemplary embodiments, each of one or more DUs may be implemented as a virtual DU (vDU). The DUs may respectively interact with remote radio heads or remote units (RUs) (here, e.g., UIA radio units 202a). The RUs, the DUs, and the CU may, by way of fronthaul(s), midhaul(s), and backhaul(s) (e.g., backhaul(s) 206), provide (e.g., controlled) connectivity between the core network(s) 208 and UEs. In various embodiments, the RAN subsystem, including some or all of its components, may conform to open standards, such as O-RAN standards or the like.

In one or more embodiments, aspects of the resource sharing platform 210 may be implemented in one or more RICs. For instance, aspects of the resource sharing platform 210 may be implemented in a CU 212 of the RAN subsystem of network operator A and a CU 212′ of the RAN subsystem of network operator B associated with the RAN subsystem of network operator B. In some embodiments, aspects of the resource sharing platform 210 may alternatively be implemented in a coordinator system 214 that interacts with both the CU 212 and the CU 212′.

In various embodiments, the resource sharing platform 210 may, in conjunction with the capabilities of the UIA radio units 202a and the functionality of generative AI (i.e., gen-AI model(s) 209), facilitate sharing of resources in one or more domains. As an example, the resource sharing platform 210 may facilitate sharing of resources in the time domain, where for a given frequency or frequency range, certain time slots are allocated for traffic associated with subscribers of network operator A and other time slots are allocated for traffic associated with subscribers of network operator B. As another example, the resource sharing platform 210 may additionally, or alternatively, facilitate sharing of resources in the frequency domain, where, for the same or different time slots, a particular frequency or frequency range is allocated for traffic associated with subscribers of network operator A and another frequency or frequency range is allocated for traffic associated with subscribers of network operator B. As yet another example, the resource sharing platform 210 may additionally, or alternatively, facilitate sharing of resources in the spatial domain. The spatial domain refers to the physical space where signals are transmitted and received. It is a three-dimensional (3D) space that includes the position and orientation of antennas, as well as the distances between them. In traditional wireless systems, the spatial domain is often considered a fixed or static environment, with antennas located at specific positions and angles. However, in modern wireless networks, such as massive MIMO systems, the spatial domain has become more dynamic and adaptive, with the ability to adjust antenna arrays and beamforming patterns in real-time. Beamforming is a technique used to direct energy towards specific targets or users in the spatial domain. Beamforming involves adjusting the phase and amplitude of signals transmitted from multiple antennas to create a directional beam that can be steered towards a desired direction or user. Beamforming is particularly useful in scenarios where there are many users or devices competing for limited resources, such as in cellular networks or Wi-Fi systems with a large number of connected devices. By focusing energy on specific targets, beamforming can improve the signal-to-noise ratio (SNR), increase system capacity, and reduce interference. In one example implementation, the resource sharing platform 210 may facilitate sharing of resources in the spatial domain by allocating certain beams at certain angles for traffic associated with subscribers of network operator A and allocating other beams at other angles for traffic associated with subscribers of network operator B. It is to be understood and appreciated that the resource sharing platform 210 may facilitate resource sharing in multiple domains—e.g., in the time domain and the frequency domain, in the time domain and the spatial domain, in the frequency domain and the spatial domain, or in the time domain, the frequency domain, and the spatial domain.

In one or more embodiments, the generative AI model(s) 209 may include one or more large language models (LLMs), one or more transformer-based model(s), one or more auto-regressive models, one or more of another type of generative AI model, or a combination of some or all of these models. In some embodiments, the generative AI model(s) 209 may be at least partially implemented in the resource sharing platform 210. In alternate embodiments, the generative AI model(s) 209 may be implemented in distributed agents throughout one or more components of the RAN subsystem and/or the core subsystem. In any case, the generative AI model(s) 209 may have access to and/or be trained on a vast array of information about the overall network, and may, based on such access/training, facilitate dynamic decision-making on whether, when, and/or how to share or exchange resources of an operator's network with other network operator(s). As an example, the generative AI model(s) 209 may have access to real-time data on network topology, performance metrics, and/or radio resource management. For instance, the generative AI model(s) 209 may be aware of the current network load (e.g., averaging around 80%) where a peak load (e.g., 95%+) was reached during rush hour yesterday. The generative AI model(s) 209 may have access to historical data to know that this trend has held steady over the past quarter, with minor fluctuations due to changes in user behavior and service usage patterns. Historical network performance metrics may include average latency, peak latency, average throughput, peak throughput, and so on. The generative AI model(s) 209 may have access to information relating to radio bearer utilization (e.g., currently at an average of 70% capacity, with peaks reaching as high as 90%), which the generative AI model(s) 209 may use to predict upcoming network load and make proactive decisions about resource sharing. In terms of quality-of-service (QOS) metrics, the generative AI model(s) 209 may have access to information relating to latency, transmission speed, transmission frequency, data throughput, routing, uplink/downlink, quality of service class identifiers (QCIs), voice quality, video quality, and/or the like, and may use such information to determine whether metrics have been relatively stable or if there are signs of strain during peak hours. For example, the generative AI model(s) 209 may determine that yesterday's morning commute saw a noticeable decrease in voice quality for a certain set of subscribers, while data throughput dropped for another set of subscribers. The generative AI model(s) 209 may also have information regarding mobility and handover patterns within the network. For instance, the generative AI model(s) 209 may know that over the past month, there was an average of 500 handovers per minute, with an average latency of 20 ms. Some or all of the foregoing information may be used by the generative AI model(s) 209 to determine whether to share or exchange resources with another operator.

It will be understood and appreciated that generative AI-enabled resource sharing may be facilitated automatically with little to no user input. As an example of resource sharing platform 210 and generative AI functionality coordination, network operator B (e.g., CU 212′ or an exchange proxy/point of network operator B) may submit a request for resources in the time domain, the frequency domain, and/or the spatial domain—e.g., 15 ms of time slot(s) desired for carrying traffic for a subscriber of network operator B, spectrum that is available for carrying the traffic, and/or particular beam(s) (e.g., at certain angle(s) with particular beamwidth) for carrying the traffic. The resource sharing platform 210 may, responsive to the request, leverage the generative AI model(s) 209 to determine whether, how, and/or when to share such resources with network operator B. For instance, the generative AI model(s) 209 may determine, based on its trained parameters, whether sharing particular resources would negatively impact the network performance for subscriber(s) of network operator A (e.g., whether sharing requested resources would cause throughput for those subscriber(s) of network operator A to suffer by more than a threshold amount, such as increase latency by more than 5 ms, 10 ms, etc.). Where the generative AI model(s) 209 predict that sharing the particular resources would negatively impact the network performance for those subscriber(s) of network operator A (e.g., that sharing the requested resources would cause throughput for those subscriber(s) of network operator A to suffer by more than the threshold amount), recommend to the resource sharing platform 210 to reject the request. In a case where the generative AI model(s) 209 determine that sharing the particular resources would be acceptable (e.g., throughput for those subscriber(s) of network operator A would not suffer by more than the threshold amount), the generative AI model(s) 209 may allocate the requested resources for use by the network system of operator B. As one example, the generative AI model(s) 209 may predict parameters for controlling a traffic scheduler system (e.g., in or associated with the resource sharing platform 210) such that traffic for subscriber(s) of network operator A and the subscriber of network operator B do not overlap in time on the same transmission frequency.

FIG. 2B illustrates an example grid or layout of base stations equipped with UIA radio units (e.g., UIA radio units 202a) in accordance with various aspects described herein. The base stations may be spread out geographically, and may include a first set of base stations 220x that have particular operating characteristics and a second set of base stations 220y with different operating characteristics. For instance, the base stations 220x may be configured to allow for high electrical tilt (e.g., where the antenna(s) are capable of tilting downwardly or upwardly at greater than a threshold tilt angle), moderate transmit power (e.g., above a first threshold power value, but below a second threshold power value), or a combination thereof, whereas the base stations 220y may be configured to allow for low electrical tilt (e.g., where the antenna(s) are capable of tilting downwardly or upwardly at no greater than a threshold tilt angle), high transmit power (e.g., above the second threshold power value, etc.), or a combination thereof. In an example scenario, the base stations 220x and 220y may be operated by network operator A. In a case where particular base station resources are requested to be shared by network operator A to serve subscribers of network operator B, the resource sharing platform 210 may decide to share certain base station resources in a manner that does not compromise the performance of the network for subscribers of network operator A. For instance, where lower electrical tilt requirements, higher transmit power, or both are requested to serve subscribers of network operator B, the resource sharing platform 210 may designate base stations 220y to be shared for use by the system of network operator B. Of course, the sharing may be implemented (e.g., in the time domain, frequency domain, and/or spatial domain) subject to any constraints determined by the generative AI functionality, such that subscribers of network operator A can continue to be served by those base stations 220y alongside subscribers of network operator B without performance (e.g., latency, throughput, etc.) associated with subscribers of network operator A falling below particular thresholds.

In various embodiments, the resource sharing platform 210 may enable network operator B to customize the characteristics of the shared base station resources (e.g., setting of particular antenna tilt angles at different times, controlling the amount of transmit power used for communications, and/or the like). Where the base station resources are also to be used for subscribers of network operator A, the resource sharing platform 210 may, similar to that described above, leverage the generative AI functionality to predict whether certain requested customizations of base station parameters would negatively impact network performance for subscribers of network operator A, and permit/deny the requested customizations based on the predictions.

Enabling intelligent and informed sharing of spectrum (as triggered or facilitated by the generative AI functionality) improves spectrum utilization efficiency and allows for higher data speed transmissions (e.g., in the uplink, the downlink, or both), which is particularly useful in cases where different network operators serve their subscribers in the same geographic areas. In certain embodiments, the network operator that receives shared spectrum may perform dynamic carrier aggregation (CA) in which multiple component carriers—i.e., that operator's own spectrum as well as the spectrum that has been shared with that operator—are leveraged to carry subscriber traffic. In these embodiments, the operator's own spectrum may be used as physical resource blocks (PRBs) for a primary cell, and the shared spectrum may be used as PRBs for a secondary cell.

In exemplary embodiments, a spectrum exchange protocol may be used to facilitate resource sharing. The spectrum exchange protocol may be defined to aid network operators with submitting, granting, and/or rejecting spectrum exchange requests. In various embodiments, the spectrum exchange protocol may encompass multiple dimensions of information, including for instance some or all of the following:
Time: The specific timeframe/duration of the desired resource usage.
Frequency: The amount of spectrum needed (e.g., number of PRBs).
Location: The targeted geographic area (e.g., grid).
Priority and Weight: Factors indicating the importance, criticality, and value of the request.

In one or more embodiments, the spectrum exchange protocol may dictate that a spectrum exchange request must be in a particular information format, such as, for instance at least x, y, z, f, Δf, t, Δt, and P, where:
x, y, z: 3-D area grid (e.g., latitude, longitude, altitude)
f: spectrum/PRB (e.g., 180 KHz raster).
Δf: # of PRBs
t: starting time
Δt: duration
P: different priorities may be applied to more critical users/applications; priority may be initiated by a UE according to its (e.g., dynamic) user profiles.

In various embodiments, the 3-D area grid may be associated with predetermined weights Wa, Wf, and Wt, where:
Wa: weights that can be applied for more valuable grids (e.g., those associated with urban areas)
Wf: weights that can be applied for different frequencies (e.g., low, mid-band, or millimeter wave (mmWave))
Wt: weights that can be applied for critical times (e.g., peak/rush hour)

In some embodiments, a network operator (e.g., each network operator) may establish a proxy/firewall to handle the submission of and/or the receipt of spectrum exchange requests. FIG. 2C illustrates example implementations of resource exchange proxies/points 232, 232′ that respective network operators A and B may provide for handling spectrum exchange requests, in accordance with various aspects described herein. The resource exchange proxies/points 232, 232′ may be respectively coupled to RAN/core subsystems of the network operators. As one example, a given resource exchange proxy/point may be implemented in a resource exchange platform, such as the resource exchange platform 210 described above with respect to FIG. 2A. In another example, a given resource exchange proxy/point may be implemented in another system that is communicatively coupled to the resource exchange proxy/point.

A spectrum exchange request grant/rejection may be determined by each network operator's own criteria, such as, for instance, their own traffic needs, spectrum availability, etc. In some embodiments, spectrum exchange may be treated as a currency, where different spectrum may have different “values”. For instance, the currency value of a particular spectrum may be defined as Δf*Δt*weights. In one example arrangement of spectrum sharing, a network operator that “borrows” spectrum from another may compensate for it via monetary payment in accordance with net gains/losses from the spectrum exchange.

FIG. 2D illustrates an example spectrum exchange flow between the systems of two network operators, in accordance with various aspects described herein. At 242, network operator B may (e.g., via resource exchange proxy 232′) initiate the exchange process by sending a spectrum exchange request to network operator A (e.g., resource exchange proxy 232). The request may be based on a determination by network operator B (e.g., the CU 212′ or another network system) that there is a need to seek available spectrum from another network operator, such as network operator A. The need may be in accordance with identified issues with traffic throughput, network performance issues, detected high priority UE traffic, or the like. The network operator A (e.g., resource exchange proxy 232, the resource sharing platform 210, the CU 212, and/or the generative AI functionality) may evaluate the request against its available spectrum resources, grid utilization, etc. Network operator A may reject, grant, or offer alternate resources to be shared depending on a result of the evaluation. An offer of alternate resources may be, for example, an offer of frequency block Y for three minutes instead of the requested frequency block X for five minutes. Here, at 244, network operator A may reject the request. At 246, network operator B may re-negotiate for the requested resources by increasing a priority level (which may, in some implementations, come with a higher cost for loaning the resources). This re-negotiation process may go back and forth until network operator A ultimately decides to grant the request at 248 (whether based on an altered request, changes in the conditions of network operator A's network, etc.). Upon grant, network operator B may begin to utilize the borrowed spectrum via the appropriate or allocated UIA radio unit(s).

In some embodiments, a UE may be capable of (e.g., equipped with hardware, firmware, or a combination of hardware and software that has functionality for) sniffing, sensing, or otherwise detecting another network operator's available or idle spectrum, and may provide information regarding the detection to its own associated network operator. This enables UE-assisted spectrum exchange request initiation(s) in which the associated network operator's network system can submit a spectrum exchange request to the other network operator's network system according to the information so as to facilitate resource acquisition for serving the UE.

It is to be understood and appreciated that, while various embodiments of resource sharing are described above as involving a UIA radio unit, certain aspects of the resource sharing may nevertheless be facilitated even if the antennas are not necessarily integrated with the radios. For instance, while advanced features such as beamforming or power allocation may not be feasible or practical for sharing in a configuration where the antennas are not integrated with the radios, spectrum sharing may still be available in such a configuration. Further, certain resources that are dedicated for particular networks, such as those operated for first responders, emergency personnel, or the like, may be off-limits and thus prohibited from being shared. Here, the generative AI, for instance, may exclude such resources from being factored into the evaluation of a resource sharing request.

It is also to be understood and appreciated that resource sharing is not limited to tower-top base station deployments. Indeed, aspects of resource sharing described herein may be extended to other types of network implementations. As an example, aspects of the resource sharing described herein may be additionally, or alternatively, adapted for cell-on-wings (COW) implementations and/or drones that are deployed for emergency situations, such as disaster recovery, search and rescue, etc. As another example, aspects of the resource sharing described herein may be additionally, or alternatively, adapted for access networks that employ satellites for remote areas, war zones, etc. As yet another example, aspects of the resource sharing described herein may be additionally, or alternatively, adapted to facilitate creation of virtual private networks (VPNs). In this example, VPNs may be at least partially created or supported via shared resources of one or more base stations or sites. This advantageously provides VPN operators with flexibility and agility in time and scale, allowing for VPN creation with customized RAN characteristics.

It is further to be understood and appreciated that, although one or more of FIGS. 1B, 2A, 2B, 2C, and/or 2D might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, units, platforms, proxies, base stations, etc. may have been illustrated in one or more of FIGS. 1B, 2A, 2B, 2C, and/or 2D as separate components, devices, systems, units, platforms, proxies, base stations, etc., it will be appreciated that multiple components, devices, systems, units, platforms, proxies, base stations, etc. can be implemented as a single device, system, unit, platform, proxy, base station, etc., or a single device, system, unit, platform, proxy, base station, etc. can be implemented as multiple components, devices, systems, units, platforms, proxies, base stations, etc. Additionally, functions described as being performed by one device, system, unit, platform, proxy, base station, etc. may be performed by multiple components, devices, systems, units, platforms, proxies, base stations, etc., or functions described as being performed by multiple components, devices, systems, units, platforms, proxies, base stations, etc. may be performed by a single device, system, unit, platform, proxy, base station, etc.

In various embodiments, the generative AI algorithm(s) described herein may be configured to reduce any error in its determinations/predictions, recommended action(s), proposes scheduler parameters, and so on. In this way, any error that may be present may be provided as feedback to the algorithm(s), such that the error may tend to converge toward zero as the algorithm(s) are utilized more and more.

FIG. 2E depicts an illustrative embodiment of a method 250 in accordance with various aspects described herein. In some embodiments, one or more process blocks of FIG. 2E can be performed by a resource sharing platform, such as the resource sharing platform 210 and/or the exchange proxy/point 232.

At 251, the method can include receiving, by a first processing system associated with a first operator of a first network and from a second processing system associated with a second operator of a second network, a request to share one or more radio access network (RAN) resources of the first network. For example, the resource sharing platform 210 can, similar to that described above with respect to the system 200 of FIG. 2A, perform one or more operations that include receiving, from a processing system (e.g., CU 212′ and/or exchange proxy/point 232′) of operator B, a request to share one or more radio access network (RAN) resources of the network of operator A.

At 252, the method can include responsive to the receiving the request, utilizing one or more generative artificial intelligence (AI) models to determine whether the one or more RAN resources are to be shared, resulting in a determination. For example, the resource sharing platform 210 can, similar to that described above, perform one or more operations that include responsive to the receiving the request, utilizing one or more generative artificial intelligence (AI) models 209 to determine whether the one or more RAN resources are to be shared, resulting in a determination.

At 253, the method can include based on the determination indicating that the one or more RAN resources are to be shared, causing the one or more RAN resources to be allocated for use by the second network. For example, the resource sharing platform 210 can, similar to that described above, perform one or more operations that include based on the determination indicating that the one or more RAN resources are to be shared, causing the one or more RAN resources to be allocated for use by the network of operator B.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2F depicts an illustrative embodiment of a method 260 in accordance with various aspects described herein. In some embodiments, one or more process blocks of FIG. 2F can be performed by an exchange proxy/point, such as the exchange proxy/point 232′.

At 261, the method can include submitting, by a first processing system associated with a first operator of a first network, and to a second processing system associated with a second operator of a second network, a request to share one or more radio access network (RAN) resources of the second network, wherein the submitting causes a generative artificial intelligence (AI) model associated with the second processing system to determine whether the one or more RAN resources are to be shared, resulting in a determination. For example, the CU 212′ and/or the exchange proxy/point 232′ of operator B can, similar to that described above, perform one or more operations that include submitting to the resource sharing platform 210 of the network of operator A, a request to share one or more radio access network (RAN) resources of that network, wherein the submitting causes a generative artificial intelligence (AI) model 209 associated with the resource sharing platform 210 to determine whether the one or more RAN resources are to be shared, resulting in a determination.

At 262, the method can include based on the determination, receiving, from the second processing system, an indication of the one or more RAN resources being allocated for use by the first network. For example, the CU 212′ and/or the exchange proxy/point 232′ can, similar to that described above, perform one or more operations that include based on the determination, receiving, from the resource sharing platform 210, an indication of the one or more RAN resources being allocated for use by the network of operator B.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

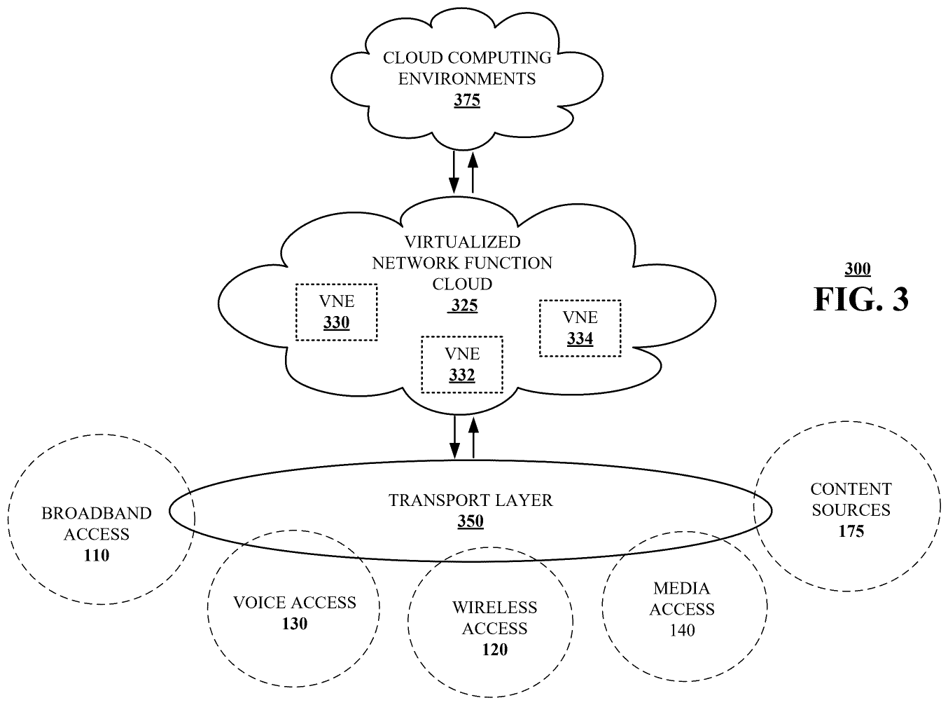

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 105, the subsystems and functions of systems 200, 220, 230, and methods 240, 250, 260 presented in FIGS. 1B and 2A to 2F. For example, virtualized communications network 300 can facilitate, in whole or in part, leveraging of generative AI for intelligent sharing/exchange of resources (e.g., spectrum, beamforming capabilities, electrical tilt capabilities, Tx power capabilities, etc.).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1B), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

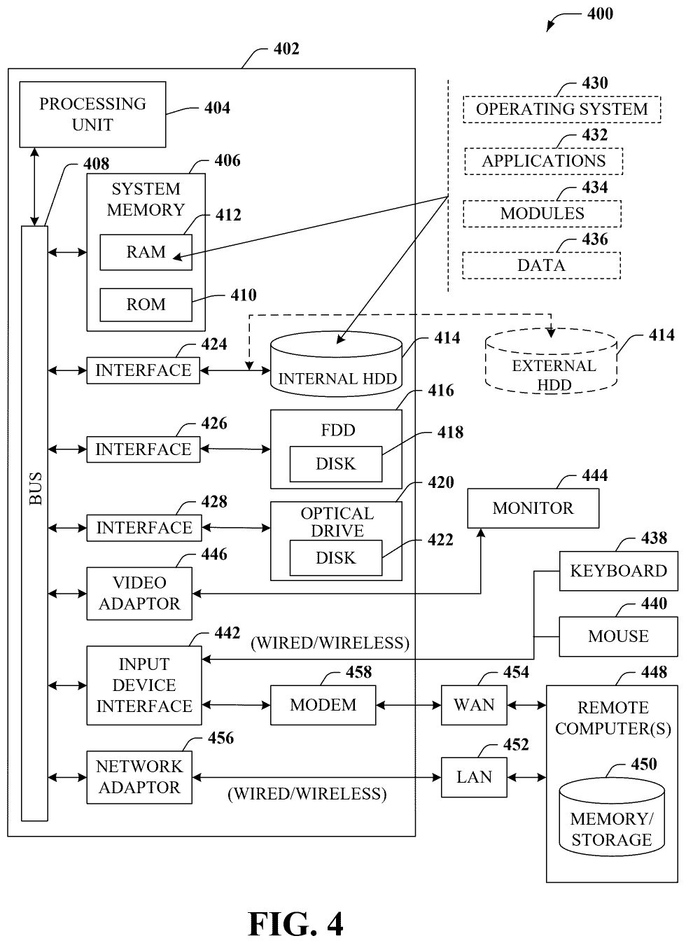

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, leveraging of generative AI for intelligent sharing/exchange of resources (e.g., spectrum, beamforming capabilities, electrical tilt capabilities, Tx power capabilities, etc.).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

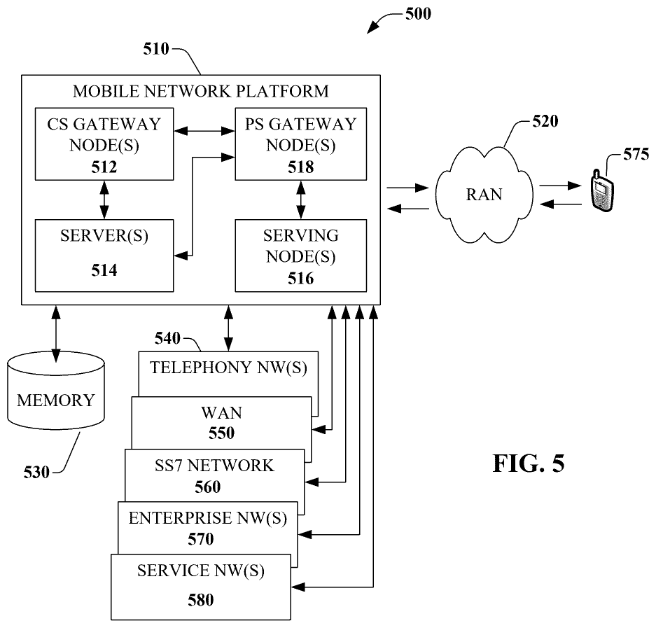

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, leveraging of generative AI for intelligent sharing/exchange of resources (e.g., spectrum, beamforming capabilities, electrical tilt capabilities, Tx power capabilities, etc.). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

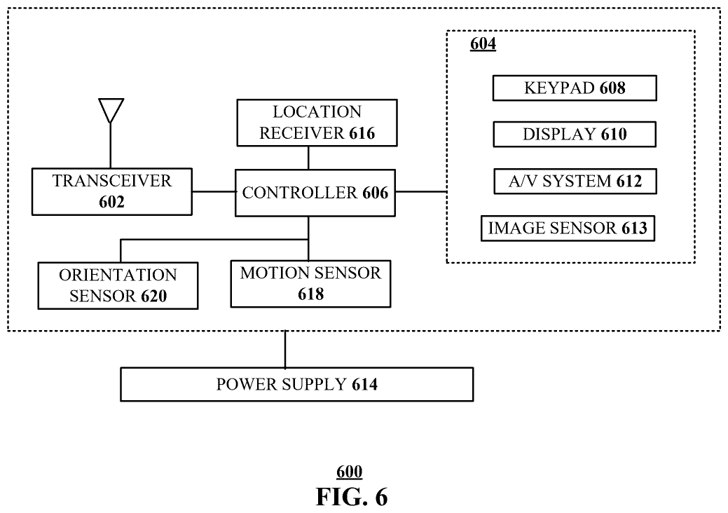

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, leveraging of generative AI for intelligent sharing/exchange of resources (e.g., spectrum, beamforming capabilities, electrical tilt capabilities, Tx power capabilities, etc.).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a first processing system associated with a first operator of a first network and including a processor; and
a memory that stores executable instructions that, when executed by the first processing system, facilitate performance of operations, the operations comprising:
receiving, from a second processing system associated with a second operator of a second network, a request to share one or more radio access network (RAN) resources of the first network;
responsive to the receiving the request, utilizing one or more generative artificial intelligence (AI) models to determine whether the one or more RAN resources are to be shared, resulting in a determination; and
based on the determination indicating that the one or more RAN resources are to be shared, causing the one or more RAN resources to be allocated for use by the second network.

2. The device of claim 1, wherein the one or more RAN resources comprise one or more integrated antenna radio units.

3. The device of claim 1, wherein the one or more RAN resources comprise physical resource blocks in a frequency domain.

4. The device of claim 1, wherein the one or more RAN resources comprise physical resource blocks in a time domain.

5. The device of claim 1, wherein the one or more RAN resources comprise physical resource blocks in a spatial domain.

6. The device of claim 1, wherein the request identifies a particular antenna electrical tilt capability.

7. The device of claim 1, wherein the request identifies a particular transmit power requirement.

8. The device of claim 1, wherein the one or more generative AI models are trained on historical data.

9. The device of claim 1, wherein the one or more generative AI models are trained to make the determination indicating that the one or more RAN resources are to be shared only if sharing of the one or more RAN resources is determined to impact service for one or more subscribers of the first network by less than a threshold amount.

10. The device of claim 1, wherein the first network operates in a different spectrum than the second network.

11. The device of claim 1, wherein the request is based on information provided by one or more subscriber devices of the second network regarding detected available spectrum associated with the first network.

12. The device of claim 1, wherein the first processing system is at least partially implemented in a RAN intelligent controller.

13. The device of claim 1, wherein the first processing system, the one or more generative AI models, or both are distributed across multiple components of the RAN.

14. The device of claim 1, wherein the request is in a format that includes one or more of the following:
three-dimensional (3D) location information;
spectrum information;
number of physical resource blocks (PRBs);
starting time;
duration; and
priority information.

15. The device of claim 1, wherein resources of the first network are identified in various three-dimensional (3D) grid areas that are respectively assigned a corresponding weight, resulting in corresponding weights that are usable to facilitate the determination, and wherein the corresponding weights include one or more weights associated with a determined grid value, one or more weights associated with one or more frequency bands, one or more weights associated with determined critical time periods, or a combination thereof.

16. A non-transitory machine-readable medium, comprising executable instructions that, when executed by a first processing system associated with a first operator of a first network and including a processor, facilitate performance of operations, the operations comprising:
submitting, to a second processing system associated with a second operator of a second network, a request to share one or more radio access network (RAN) resources of the second network, wherein the submitting causes a generative artificial intelligence (AI) model associated with the second processing system to determine whether the one or more RAN resources are to be shared, resulting in a determination; and
based on the determination, receiving, from the second processing system, an indication of the one or more RAN resources being allocated for use by the first network.

17. The non-transitory machine-readable medium of claim 16, wherein the request includes three-dimensional (3D) location information.

18. The non-transitory machine-readable medium of claim 16, wherein resources of the second network are identified in various three-dimensional (3D) grid areas that are respectively assigned a corresponding weight, resulting in corresponding weights that are usable to facilitate the determination.

19. A method, comprising:
obtaining, by a first processing system associated with a first operator of a first network and including a processor, a request to share one or more radio access network (RAN) resources of the first network, wherein the request is obtained from a second processing system associated with a second operator of a second network;
responsive to the obtaining the request, leveraging, by the first processing system, one or more generative artificial intelligence (AI) models to determine whether the one or more RAN resources are to be shared, resulting in a determination; and
based on the determination indicating that the one or more RAN resources are to be shared, causing, by the first processing system, the one or more RAN resources to be allocated for use by the second network, wherein the one or more RAN resources include particular spectrum associated with the first network.

20. The method of claim 19, wherein the request is obtained via a spectrum exchange protocol that enables the first processing system and the second processing system to negotiate resource sharing.
